(19) United States
(12) Patent Application Publication
(10) Pub. No.: US 2026/0246869 A1
(43) Pub. Date: Aug. 20, 2026

(54) SYSTEMS AND METHODS FOR CUSTOMIZED INTERACTIVE VOICE RESPONSE (IVR) FLOW CONSTRUCTION AND DEPLOYMENT

(71) Applicant: GENESYS CLOUD SERVICES, INC., MENLO PARK, CA (US)

(72) Inventors: PRAVEEN KUMAR ANANDADOSS, CHENNAI (IN); MOHAMED UVAIZ ANWAR BATCHA, CHENNAI (IN); MCFERRAN ABISHEK, CHENNAI (IN); AISHWARYA KOTIAN, HYDERABAD (IN)

(73) Assignee: GENESYS CLOUD SERVICES, INC., MENLO PARK, CA (US)

(21) Appl. No.: 19/055,852

(22) Filed: Feb. 18, 2025

(51) Int. Cl. H04M 3/493; G06F 40/20

(52) U.S. Cl. CPC H04M 3/4936; G06F 40/20; H04M 2203/558

(57) ABSTRACT

A system and method for identifying relevant intents from an inbound interaction of a conversation bot, to construct customized Interactive Voice Response (IVR) flows, is disclosed. The system includes a contextual embedding module, to generate a vector database and an input vector representation database and an utterance context identification module, to identify a list of potentially relevant utterances in the vector database which are contextually similar to the input vector representation database and re-rank the list of potentially relevant utterances to obtain a reranked list of potentially relevant utterances. The system further includes a pretrained LLM, to match a relevant intent to each of the potentially relevant utterances in the re-ranked list and assign intent valuation score, an IVR flow construction service, to construct customized IVR flows based on the intent with the highest intent valuation score and an IVR flow validation module, to validate the constructed customized IVR flow.

### FIELD OF THE INVENTION

The present invention generally relates to customer relations services and customer relations management via contact centers and associated cloud-based systems. More particularly, but not by way of limitation, the present invention pertains to systems and methods for customized Interactive Voice Response (IVR) flow construction and deployment based on requirements gathered from users/consultants via conversational bots.

### BACKGROUND

Interactive Voice Response (IVR) systems have become crucial in modern day call center operations, acting as the first point of contact between customers and businesses. These systems enable automated interactions, allowing customers to navigate menus, access information, and perform tasks such as scheduling appointments, technical support, account updates, booking tickets and so on. The efficiency and cost-effectiveness of IVR systems make them essential for managing high volumes of customer inquiries and transactions. Think of it as a digital receptionist guiding callers through various options using keypad input or voice commands. Generally, IVR systems are developed using complex, code-based methods. This involves writing extensive scripts and logic to handle various call scenarios, requiring significant programming expertise and resources. Developers manually code the entire IVR flow, including menu options, prompts, and routing rules. Maintaining and updating these systems is labor-intensive, often requiring a deep understanding of both the underlying code and the specific business requirements. Consequently, traditional IVR development is time-consuming and prone to errors and inefficiencies. To address these challenges, the industry moved towards more user-friendly development methods. The introduction of widget-based platforms marked a significant improvement, allowing non-technical users to design IVR systems through graphical interfaces. These platforms offer a drag-and-drop functionality, enabling the creation and modification of IVR systems without detailed coding knowledge which significantly reduces the time and cost associated with implementing and maintaining these systems. The latest advancement in IVR technology is the integration of Artificial Intelligence (AI). AI-powered automation has revolutionized the development and operation of IVR systems. By leveraging natural language processing (NLP) and machine learning algorithms, AI can automate the creation of IVR flows. Despite these advancements, construction and deployment of customized IVR flows to meet specific business requirements remains a challenge.

### BRIEF DESCRIPTION OF THE INVENTION

Techniques are provided for customized Interactive Voice Response (IVR) flow construction and deployment based on requirements gathered from users/consultants via conversational bots.

In an example embodiment, the system described herein includes a system for identifying relevant intents from an inbound interaction of a conversation bot, to construct customized Interactive Voice Response (IVR) flows which includes a contextual embedding module, to generate a vector database and an input vector representation database, wherein the vector database is generated by contextually embedding information in a knowledge base and the input vector representation database is generated by contextually embedding the inbound interaction of the conversation bot.

The system further includes an utterance context identification module, to identify a list of potentially relevant utterances in the vector database generated by the contextual embedding module, which are contextually similar to the input vector representation database generated by the contextual embedding module, and re-rank the identified list of potentially relevant utterances to obtain a reranked list of potentially relevant utterances.

The system further includes a pretrained LLM, to match a relevant intent to each of the potentially relevant utterances in the re-ranked list derived from the context identification module and assign intent valuation scores to each of the intents matched. The system further includes an IVR flow construction service, to construct customized IVR flows based on the intent with the highest intent valuation scores assigned by the pre-trained LLM and an IVR flow validation module, to validate the constructed customized IVR flow.

In an example embodiment, the system described herein includes a knowledge base which is based on at least one of existing customer flows and user inputs and is utilized for creating the vector database.

In an example embodiment, the inbound interaction of the conversation bot is either a voice input or text input.

In an example embodiment, the system described herein includes an IVR flow validation module which assigns a quality score to the constructed customized IVR flow wherein the IVR flow validation module transmits the assigned quality score to the pre-trained LLM for reinforcement learning of the pre-trained LLM in real time.

In an example embodiment, the system described herein includes an IVR flow validation module which assigns a quality score to the constructed customized IVR flow wherein the quality score assigned by the IVR flow validation module ranges between 0 and 1.

In an example embodiment, the system described herein includes an IVR flow validation module wherein the IVR flow validation module defines a dynamic threshold value for the quality score and on obtaining a quality score below the dynamic threshold value for the constructed customized IVR flow, transmits an alert to the user for manual validation and on obtaining a quality score above the dynamic threshold value for the constructed customized IVR flow, transmits the constructed customized IVR flow to the deployment module for deployment.

In an example embodiment, the method described herein includes a method for identifying relevant intents from an inbound interaction of a conversation bot, to construct customized Interactive Voice Response (IVR) flows and the method comprises generating, by a contextual embedding module, a vector database and an input vector representation database wherein the vector database is generated by contextually embedding information in a knowledge base and the input vector representation database is generated by contextually embedding the inbound interaction of the conversation bot; identifying, by an utterance context identification module a list of potentially relevant utterances in the vector database generated by the contextual embedding module, which are contextually similar to the to the input vector representation database generated by the contextual embedding module, and re-rank the identified list of potentially relevant utterances to obtain a reranked list of potentially relevant utterances; matching, by the pretrained LLM a relevant intent to each of the potentially relevant utterances in the re-ranked list derived from the context identification module and assigning intent valuation scores to each of the intents matched; constructing, by an IVR flow construction service, customized IVR flows based on the intent with the highest intent valuation scores assigned by the pre-trained LLM; and validating, by a IVR flow validation module, the constructed customized IVR flow.

In an example embodiment, the method described herein includes a knowledge base, utilized for creating the vector database which is based at least one of existing customer flows and user inputs.

In an example embodiment, the inbound interaction of the conversation bot, is either a voice input or text input.

In an example embodiment, the method described herein includes an IVR flow validation module which assigns a quality score to the constructed customized IVR flow wherein the IVR flow validation module transmits the assigned quality score to the pre-trained LLM for reinforcement learning of the pre-trained LLM in real time.

In an example embodiment, the method described herein includes an IVR flow validation module which assigns a quality score to the constructed customized IVR flow wherein the quality score assigned by the IVR flow validation module ranges between 0 and 1.

In an example embodiment, the method described herein includes an IVR flow validation module wherein the IVR flow validation module defines a dynamic threshold value for the quality score and on obtaining a quality score below the dynamic threshold value for the constructed customized IVR flow, transmits an alert to the user for manual validation and on obtaining a quality score above the dynamic threshold value for the constructed customized IVR flow, transmits the constructed customized IVR flow to the deployment module for deployment.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 depicts a simplified block diagram of a system for customized IVR flow construction and deployment based on conversation bots, in accordance with exemplary embodiments of the present invention; and

FIG. 4 depicts a flowchart illustrating a method for customized IVR flow construction and deployment based on conversation bots in accordance with exemplary embodiments of the present invention.

### DETAILED DESCRIPTION

For the purpose of understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail to avoid obscuring the present invention. Additionally, further modification in the provided examples or application of the principles of the invention, as presented herein, are contemplated as would normally occur to those skilled in the art. Particular features, structures or characteristics may be combined in any suitable combinations and/or sub-combinations in one or more embodiments or examples. Those skilled in the art will recognize that various embodiments may be computer implemented using many different types of data processing equipment, with embodiments being implemented as a system, method, or computer program product. Example embodiments, thus, may take the form of a hardware embodiment, a software embodiment, or combination thereof.

### Introduction

Modern day contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes. IVR systems are perfect for voice-based interactions, especially in scenarios like call routing, managing high call volumes, and providing frequently requested information. While traditional IVR can be limited by its rigid options, AI-powered conversational IVR enhances user experience. Companies often use a combination of IVR and voice bots to deliver a seamless experience across both voice and digital channels.

Techniques are disclosed herein for customized IVR flow construction and deployment based on conversation bots. While the techniques described herein are not tailored to any specific machine learning model, the techniques work best with any model utilizing word embeddings or their variations as features. The system uses multi-lingual NLU domains where intents and utterances belonging to multiple languages are separately defined, without any major changes to the system described.

### Computing Device

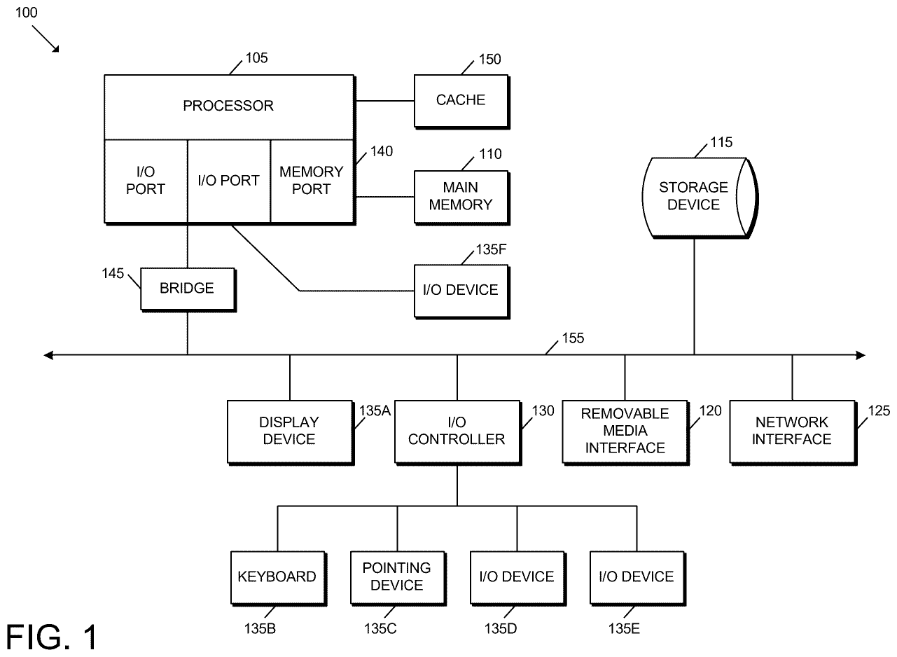

It will be appreciated that the systems and methods of the present invention may be computer implemented using different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced. It should be understood that FIG. 1 is provided as a non-limiting example.

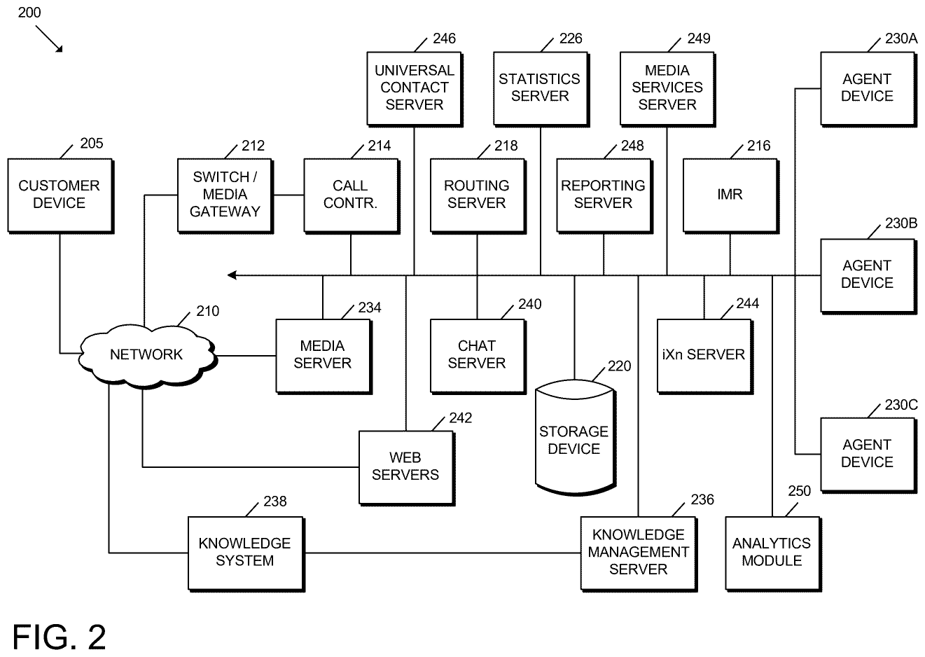

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures, such as for example, the contact center system 200 of FIG. 2 the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to, and processes instructions fetched from the main memory 110. For example, the processor 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The main memory 110 may be one or more memory chips capable of storing data and allowing stored data to be accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

Unless otherwise limited, the computing device 100 may be any workstation, desktop computer, laptop or notebook computer, server machine, virtualized machine, mobile or smart phone, portable telecommunication device, media playing device, or any other type of computing, telecommunications or media device, without limitation, capable of performing the operations and functionality described herein. The computing device 100 may include a plurality of such devices connected by a network or connected to other systems and resources via a network. Unless otherwise limited, the computing device 100 may communicate with other computing devices 100 via any type of network using any conventional communication protocol. Further, the network may be a virtual network environment where various network components are virtualized.

### Contact Center

With reference now to FIG. 2, a communications infrastructure or contact center system (or simply “contact center”) 200 is shown in accordance with exemplary embodiments of the present invention and/or with which exemplary embodiments of the present invention may be enabled or practiced. By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between agents and customers may be conducted over a variety of communication channels, such as for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as IVR systems, interactive media response (IMR) systems, internet robots or “bots”, automated chat modules or “conversational bots”, and the like.

Referring specifically to FIG. 2, the contact center 200 may be used by a customer service provider to provide various types of services to customers. For example, the contact center 200 may be used to engage and manage interactions in which automated processes (or bots) or human agents communicate with customers. The contact center 200 may be an in-house facility of a business or enterprise for performing the functions of sales and customer service relative to products and services available through the enterprise. In another aspect, the contact center 200 may be operated by a service provider that contracts to provide customer relation services to a business or organization. Further, the contact center 200 may be deployed on equipment dedicated to the enterprise or third-party service provider, and/or deployed in a remote computing environment, such as for example, a private or public cloud environment with infrastructure for supporting multiple contact centers for multiple enterprises. The contact center 200 may include software applications or programs, which may be executed on premises or remotely or some combination thereof. It should further be appreciated that the various components of the contact center 200 may be distributed across various geographic locations.

Unless otherwise specifically limited, any of the computing elements of the present invention may be implemented in cloud-based or cloud computing environments. As used herein, “cloud computing” or, simply, the “cloud” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, or some combination thereof), service models (e.g., Software as a Service (“SaaS”), Platform as a Service (“PaaS”), Infrastructure as a Service (“IaaS”), and deployment models (e.g., private cloud, community cloud, public cloud, hybrid cloud, or some combination thereof). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center 200 may include: a plurality of customer devices 205; communications network (or simply “network”) 210; switch/media gateway 212; call controller 214; interactive media response (IMR) server 216; routing server 218; storage device 220; statistics server 226; plurality of agent devices 230 that each have a workbin 232; multimedia/social media server 234; knowledge management server 236 coupled to a knowledge system 238; chat server 240; web servers 242; interaction server 244; universal contact server (or “UCS”) 246; reporting server 248; media services server 249; and an analytics module 250. It should be understood that any of the computer-implemented components, modules, or servers described in relation to FIG. 2 or in any of the following figures may be implemented via computing devices, such as the computing device 100 of FIG. 1. As will be seen, the contact center 200 generally manages resources (e.g., personnel, computers, telecommunication equipment, or some combination thereof) to enable the delivery of services via telephone, email, chat, or other communication mechanisms. The various components, modules, and/or servers of FIG. 2 (and other figures included herein) each may include one or more processors executing computer program instructions and interacting with other system components for performing the various functionalities described herein. Further, the terms “interaction” and “communication” are used interchangeably, and generally refer to any real-time and non-real-time interaction that uses any communication channel including, without limitation, telephone calls (PSTN or VoIP calls), emails, voicemails, video, chat, screen-sharing, text messages, social media messages, WebRTC calls, or some combination thereof. Access to and control of the components of the contact system 200 may be affected through user interfaces (UIs) which may be generated on the customer devices 205 and/or the agent devices 230.

Customers desiring to receive services from the contact center 200 may initiate inbound communications (e.g., telephone calls, emails, chats, or some combination thereof) to the contact center 200 via a customer device 205. While FIG. 2 shows two such customer devices it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center 200, such as telephone calls, emails, chats, text messages, web-browsing sessions, and other multi-media transactions. Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN, such as the Internet. Further, the network 210 may include a wireless carrier network including a code division multiple access network, global system for mobile communications (GSM) network, or any wireless network/technology conventional in the art.

The switch/media gateway 212 may be coupled to the network 210 for receiving and transmitting telephone calls between customers and the contact center 200. The switch/media gateway 212 may include a telephone or communication switch configured to function as a central switch for agent routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. In general, the switch/media gateway 212 establishes a voice connection between the customer and the agent by establishing a connection between the customer device 205 and agent device 230. The switch/media gateway 212 may be coupled to the call controller 214 which, for example, serves as an adapter or interface between the switch and the other routing, monitoring, and communication-handling components of the contact center 200. The call controller 214 may be configured to process PSTN calls, VoIP calls, or some combination thereof. The call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

The interactive media response (IMR) server 216 enables automated processes, such as bot or virtual assistant functionality. Specifically, the IMR server 216 may be similar to an IVR server, except that the IMR server 216 is not restricted to voice and may also cover a variety of media channels. In an example illustrating voice, the IMR server 216 may be configured with an IMR script for querying customers on their needs. For example, a contact center for a bank may tell customers via the IMR script to “press 1” if they wish to retrieve their account balance. Through continued interaction with the IMR server 216, customers may receive service without needing to speak with an agent. The IMR server 216 may ascertain why a customer is contacting the contact center so to route the communication to the appropriate resource.

The routing server 218 routes incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230, which may enhance the service the agent is able to provide.

Regarding data storage, the contact center 200 may include one or more mass storage devices represented generally by the storage device 220 for storing data in one or more databases. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center 200 may include agent availability and agent profiles, schedules, skills, average handle time, or some combination thereof. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center 200 in ways that facilitate the functionality described herein. For example, the servers or modules of the contact center 200 may query such databases to retrieve data stored therewithin or transmit data thereto for storage.

The statistics server 226 may be configured to record and aggregate data relating to the performance and operational aspects of the contact center 200. Such information may be compiled by the statistics server 226 and made available to other servers and modules, such as the reporting server 248, which then may produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center 200 to facilitate the functionality described herein. An agent device 230, for example, may include a telephone adapted for regular telephone calls or VoIP calls. An agent device 230 may further include a computing device configured to communicate with the servers of the contact center 200, perform data processing associated with operations, and interface with customers via voice, chat, email, and other multimedia communication mechanisms according to functionality described herein. While only two such agent devices are shown, any number may be present.

The multimedia/social media server 234 may be configured to facilitate media interactions (other than voice) with the customer devices 205 and/or the servers 242. Such media interactions may be related, for example, to email, voicemail, chat, video, text-messaging, web, social media, co-browsing, or some combination thereof. The multi-media/social media server 234 may take the form of any IP router conventional in the art with specialized hardware and software for receiving, processing, and forwarding multi-media events and communications.

The knowledge management server 234 may be configured to facilitate interactions between customers and the knowledge system 238. In general, the knowledge system 238 may be a computer system capable of receiving questions or queries and providing answers in response. The knowledge system 238 may include an artificially intelligent computer system capable of answering questions posed in natural language by retrieving information from information sources, such as encyclopedias, dictionaries, newswire articles, literary works, or other documents submitted to the knowledge system 238 as reference materials, as is known in the art.

The chat server 240 may be configured to conduct, orchestrate, and manage electronic chat communications with customers. Such chat communications may be conducted by the chat server 240 in such a way that a customer communicates with automated chatbots, human agents, or both. The chat server 240 may perform as a chat orchestration server that dispatches chat conversations among chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature. The chat server 240 may be configured to transfer chats within a single chat session with a particular customer between automated and human sources. The chat server 240 may be coupled to the knowledge management server 234 and the knowledge systems 238 for receiving suggestions and answers to queries posed by customers during a chat so that, for example, links to relevant articles can be provided.

The web servers 242 provide site hosts for a variety of social interaction sites to which customers subscribe, such as Facebook, Twitter, Instagram, or some combination thereof. Though depicted as part of the contact center 200, it should be understood that the web servers 242 may be provided by third parties and/or maintained remotely. The web servers 242 may also provide webpages for the enterprise or organization being supported by the contact center 200. For example, customers may browse the webpages and receive information about the products and services of a particular enterprise. Within such enterprise webpages, mechanisms may be provided for initiating an interaction with the contact center 200, for example, via web chat, voice, or email. An example of such a mechanism is a widget, which can be deployed on the webpages or websites hosted on the web servers 242. As used herein, a widget refers to a user interface component that performs a particular function. In some implementations, a widget includes a GUI that is overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Such widgets may include additional user interfaces and be configured to access a variety of local resources (e.g., a calendar or contact information on the customer device) or remote resources via network (e.g., instant messaging, electronic mail, or social networking updates).

The interaction server 244 is configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

The universal contact server (UCS) 246 may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer, such as data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as for example, average wait time, abandonment rate, agent occupancy. The reports may be generated automatically or in response to a request and used toward managing the contact center in accordance with functionality described herein.

The media services server 249 provides audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, audio and video transcoding, secure real-time transport protocol (SRTP), audio or video conferencing, call analysis, keyword spotting, or some combination thereof.

The analytics module 250 may be configured to perform analytics on data received from a plurality of different data sources as functionality described herein may require. The analytics module 250 may also generate, update, train, and modify predictors or models, such as machine learning model 251 and/or models 253, based on collected data. To achieve this, the analytics module 250 may have access to the data stored in the storage device 220, including the customer database 222 and agent database 223. The analytics module 250 also may have access to the interaction database 224, which stores data related to interactions and interaction content (e.g., audio and transcripts of the interactions and events detected therein), interaction metadata (e.g., customer identifier, agent identifier, medium of interaction, length of interaction, interaction start and end time, department, tagged categories), and the application setting (e.g., the interaction path through the contact center). The analytic module 250 may retrieve such data from the storage device 220 for developing and training algorithms and models. It should be understood that, while the analytics module 250 is depicted as being part of a contact center, the functionality described in relation thereto may also be implemented on customer systems (or, as also used herein, on the “customer-side” of the interaction) and used for the benefit of customers.

The machine learning model 251 may include one or more artificial intelligence-based models, including machine learning models, such as neural networks, deep learning models as well as other types as described herein. As an example, the machine learning model 251 may be configured to predict behavior. Such behavioral models may be trained to predict the behavior of customers and agents in a variety of situations so that interactions may be personally tailored to customers and handled more efficiently by agents. As another example, the machine learning model 251 may be configured to predict aspects related to contact center operation and performance. In other cases, for example, the machine learning model 251 also may be configured to perform natural language processing and, for example, provide intent recognition and the like.

The analytics module 250 may further include an optimization system 252. The optimization system 252 may include one or more models 253, which may include the machine learning model 251, and an optimizer 254. The optimizer 254 may be used in conjunction with the models 253 to minimize a cost function subject to a set of constraints, where the cost function is a mathematical representation of desired objectives or system operation. Because the models 253 are typically non-linear, the optimizer 254 may be a nonlinear programming optimizer. It is contemplated, however, that the optimizer 254 may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The analytics module 250 may utilize the optimization system 252 as part of an optimization process by which aspects of contact center performance and operation are optimized or, at least, enhanced. This, for example, may include aspects related to the customer experience, agent experience, interaction routing, natural language processing, intent recognition, allocation of system resources, system analytics, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as for example, a random-access memory (RAM), or stored in other non-transitory computer readable media, such as for example, a CD-ROM, flash drive, or some combination thereof. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, or some combination thereof. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment.

### Customized Interactive Voice Response (IVR) Flow Construction and Deployment Based on Conversation Bots

Modern day contact centers regularly employ automated processes, such as IVR systems in place of live agents. The IVR systems are based on an IVR flow architecture which is a graphical representation of the interactions between the IVR system and a caller. This IVR flow architecture is similar to a voicemail system user manual and includes menu options, prompts, and routing rules. The IVR flow architecture may be integrated with at least one of the modules or components of the contact center 200 such as, the interactive media response (IMR) server 216 or the chat server 240 to construct IVR systems.

Traditional methods for constructing IVR flows for IVR systems require extensive manual efforts to design and implement call flows, which is both time-consuming and prone to errors. Recent systems use AI based natural language processing (NLP) to automate the creation of IVR flows for IVR systems. However, such systems may not be efficient in terms of capturing real time business requirements and are inefficient due to inaccurate identification of intents of the user/consultant utterances. Such inaccurate identification of intents may be due to inability by the AI system to comprehend user/consultant's queries or utterances leading to errors in IVR flow generation.

Systems which construct and deploy customized IVR flows after accurate identification of input utterances and their corresponding intents from the requirements collected from users/consultants through a voice/chat interfaces may lead to increased operational efficiency of IVR systems. Such IVR systems align with the business goals and may lead to improved customer experience.

In the present disclosure, the IVR flow construction and deployment module is integrated with a conversational bot which processes users/consultant's inputs and extract relevant intents from the input utterances. Users/Consultants interact with the conversational bot to specify detailed requirements for the IVR flow construction. The presented conversation bot architecture identifies using a Retrieval Augmented Generation (RAG) model the broad context of the user/consultant utterances and generates a list of potentially relevant utterances similar in context to the user/consultant utterance/query for which intents are determined by a LLM model. The determined intents are then utilized for IVR flow construction and deployment.

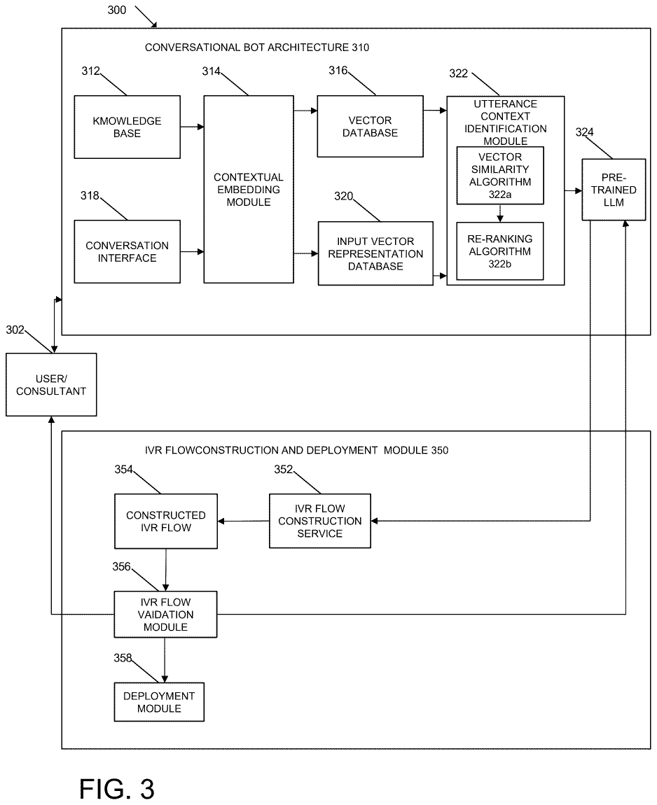

While the system and method described here is not tailored to any specific machine learning model that can be used for the purposes of natural language understanding, it may work best with those that use word embeddings or its variations as features. It should be understood that any of the computer-implemented components or modules described in relation to FIG. 3 or in any of the following figures may be implemented via types of computing devices, such as, for example, the computing device 100 of FIG. 1.

With reference now to FIG. 3, a system for customized IVR flow construction and deployment based on conversation bots 300 is shown in accordance with exemplary embodiments of the present invention and can be implemented in software only, hardware only, or a combination of hardware and software.

The system for customized IVR flow construction and deployment 300 includes a conversation bot architecture 310 integrated with an IVR flow construction and deployment module 350.

The conversation bot architecture 310 includes a knowledge base 312 which is created utilizing information such as data from existing customer call flows, and a comprehensive set of utterances gathered from expert consultants. A contextual embedding module 314 of the conversation bot architecture 310 generates embeddings of the information in the knowledge base, i.e., the contextual embedding module 314 converts the information in the knowledge base to generate fixed-size vectors, regardless of a length of the information in the knowledge base. The embeddings generated by the contextual embedding module retain context of the original information, i.e., the embeddings generated for each word of the information in the knowledge base is based on other words in a given sentence. The generated embeddings are the vector representations of the information from the knowledge base 312 and are generated by contextually embedding the information in the knowledge base 312 by a contextual embedding module 314 to form the vector database 316. In an example embodiment, the contextual embedding module 314, may be implemented using transformer-based models such as E5, BERT and RoBERTa.

The conversation bot architecture 310 further includes a conversation interface 318, wherein the conversation interface 318 receives inbound interaction from user/consultant where the inbound interactions are user/consultant requirements or inputs to construct an IVR flow. The user/consultant inputs are processed by the contextual embedding module 314, to generate embeddings of user/consultant requirements, i.e., the contextual embedding module 314 converts the user/consultant inputs into a fixed-size vectors, regardless of a length of the information in the knowledge base. The embeddings generated by the contextual embedding module retain context of the original information, i.e., the embeddings generated for each word of user/consultant inputs is based on other words in the given input. The generated embeddings are the vector representations of inbound interactions from the user/consultant, and are, generated by contextually embedding the inbound interactions from the user/consultant by a contextual embedding module 314 to form the input vector representation database 320. In an example embodiment, the contextual embedding module 314, may be implemented using transformer-based models such as E5, BERT and RoBERTa.

The conversation bot architecture 310, further includes an utterance context identification module 322, based on a Retrieval Augmented Generation (RAG) model which identifies a broad context of the user/consultant utterances and generates a list of potentially relevant utterances similar in context to the user/consultant utterances. The utterance context identification module 322 comprises of a vector similarity algorithm 322a and a re-ranking algorithm 322b. The vector similarity algorithm 322a of the utterance context identification module 322 determines utterances in the knowledge base which broadly matches the context of the user/consultant inputs by estimating the similarity between the input vector representations and vector representations of the information in the knowledge base 312. Through estimation of the similarity between the input vector representations and vector representations of the information in the knowledge base 312, the vector similarity algorithm 322a identifies the list of potentially relevant utterances in the knowledge base which are contextually similar to the user/consultant inputs. In an example embodiment, cosine similarity technique is used to determine similarity between input vector representations and the vector representations of the information in the knowledge base 312 to identify the list of potentially relevant utterances.

Once, the list of potentially relevant utterances which broadly matches the context of the user/consultant inputs are identified, the list of potentially relevant utterances is reranked by the utterance context identification module by utilizing a reranking algorithm 332b which selects the top candidates in the list. The re-ranking algorithm is based on various parameters such as, consultant preferences, consultant inputs, interaction history etc.

The re-ranked list of potentially relevant utterances from the utterance context identification module 322 are then input to a pre-trained Large Language Model (LLM) 324 to match a relevant intent to each of the potentially relevant utterances in the re-ranked list. The pre-trained LLM model of the conversational bot architecture 310 is typically trained by first defining intents and associated utterances by a bot author wherein the intents and associated utterances are based on various flows associated with IVR. Broadly, intents refer to user/consultant goals or intentions that the bot needs to fulfil or respond to. Utterances denote the various ways in which a user/consultant can describe these goals or intentions. Together, they form the NLU domain of the bot flow architecture. In order to train machine learning models for NLU, defining the right set of intents and utterances is of great importance. The NLU domain of the pre-trained Large Language Model (LLM) 324 matches a relevant intent to each of the potentially relevant utterances in the re-ranked list and further assigns intent valuation scores to the each of the re-ranked list of potentially relevant utterances and its corresponding intents. The pre-trained Large Language Model (LLM) 324 finally outputs the intent with the highest assigned intent valuation scores to an IVR flow construction and deployment module 350.

The IVR flow construction and deployment module 350 includes an IVR flow construction service 352 with a Software Development Kit (SDK) which, constructs the IVR flow 354 based on the intent with the highest assigned intent valuation score, provided by the pre-trained LLM 324. IVR flow construction service 352 creates a fully operational and customized IVR flow 354 without the need for additional development effort. This approach significantly reduces setup time, enhances adaptability to evolving requirements, and optimizes resources for businesses.

The IVR flow construction and deployment module 350 includes an IVR flow validation module 356 which validates the constructed IVR flow 354. The IVR flow validation module 356 executes validation based on various parameters such as, but not limited to sequence of flows, customer preferred language, customer type and predefined agent, and assigns a quality score to the constructed IVR flow 354. Further the IVR flow validation module 356 transmits the quality score to the pre-trained LLM 324. The quality score serves as an input for reinforcement learning of the pre-trained LLM 324 with respect to intent identification thereby enhancing the performance of the pre-trained LLM 324 in real-time.

The quality score assigned to the constructed IVR flow 354 by the IVR flow validation module 356 ranges between 0 to 1. The IVR flow validation module 356 also defines a dynamic threshold value for the quality score, based on various parameters in the created IVR flow such as, but not limited to sequence of flows, business requirements, language, customer type and predefined agent. The quality score below the dynamic threshold value indicates erroneous IVR flow construction, whereas the quality score above the dynamic threshold value indicates higher accuracy in the constructed IVR flow. The IVR flow validation module on identifying that the quality score is above the dynamic threshold value transmits the IVR flow to the deployment module 358 for deployment. The IVR flow validation module on obtaining a quality score below the dynamic threshold value transmits an alert to the user/consultant 302 for manual validation.

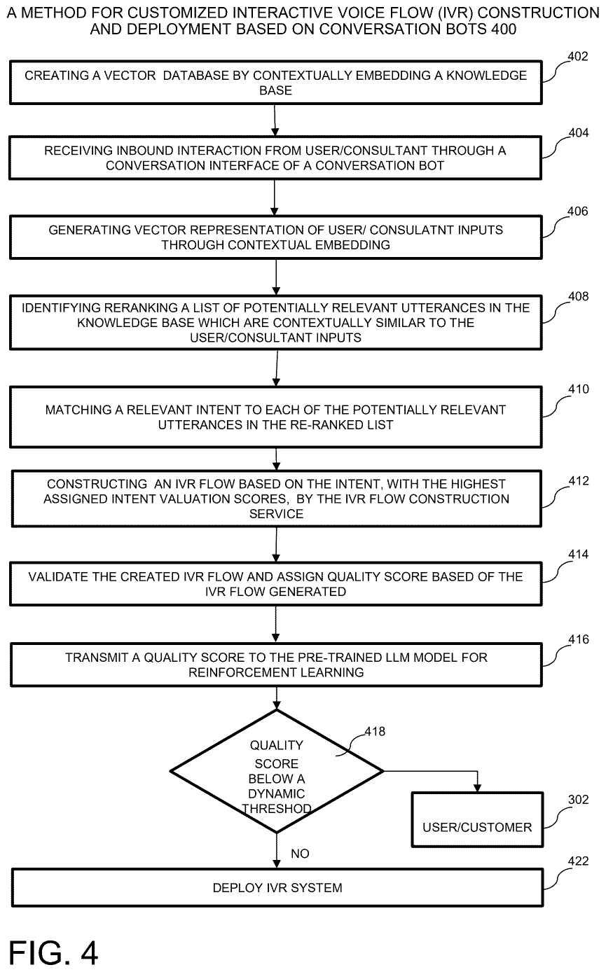

With reference now to FIG. 4, a conversation bot based automated IVR flow creation method 400 is depicted. At 402, a vector database is created by performing contextual embedding to a knowledge base. The knowledge base 312 which is created utilizing information such as, data from existing customer call flows, and a comprehensive set of utterances gathered from expert consultants. A contextual embedding module 314 converts the information in the knowledge base into a fixed-size vectors, regardless of a length of the information in the knowledge base. The embeddings generated by the contextual embedding module retain context of the original information, i.e., the embeddings generated for each word of the information in the knowledge base is based on other words in a given sentence. The generated embeddings are the vector representations of the information from the knowledge base 312 and are generated by contextually embedding the information in the knowledge base 312 by a contextual embedding module 314 to form the vector database 316.

At 404, the inbound interaction from user/consultants are received through the conversation interface of the conversation bot, where the inbound interactions are user/consultant requirements or inputs to construct an IVR flow. At 406, the vector representation of the user/consultant inputs is generated through contextual embedding, i.e., the contextual embedding module 314 converts the user/consultant inputs into a fixed-size vectors, regardless of a length of the information in the knowledge base. The embeddings generated by the contextual embedding module retain context of the original information, i.e., the embeddings generated for each word of user/consultant inputs is based on other words in the given input. The generated embeddings are the vector representations of inbound interactions from the user/consultant, and are, generated by contextually embedding the inbound interactions from the user/consultant by a contextual embedding module 314 to form the input vector representation database 320.

At 408, utterance context identification module 322, identifies a broad context of the user/consultant utterances and generates a list of potentially relevant utterances similar in context to the user/consultant utterances and re-ranks the list of potentially relevant utterances. At 410, a relevant intent is matched to each of the potentially relevant utterances in the re-ranked list and an intent valuation score is assigned by a pre-trained LLM model, where the pre-trained LLM model of the conversational bot architecture 310 is typically trained by first defining intents and associated utterances by a bot author wherein the intents and associated utterances are based on various flows associated with IVR. Broadly, intents refer to user/consultant goals or intentions that the bot needs to fulfil or respond to. Utterances denote the various ways in which a user/consultant can describe these goals or intentions. Together, they form the NLU domain of the bot flow architecture. In order to train machine learning models for NLU, defining the right set of intents and utterances is of great importance. The NLU domain of the pre-trained Large Language Model (LLM) 324 matches a relevant intent to each of the potentially relevant utterances in the re-ranked list and further assigns intent valuation scores to each pair of re-ranked list of potentially relevant utterances and its corresponding intents. The pre-trained Large Language Model (LLM) 324 finally outputs the intent with the highest assigned intent valuation scores to an IVR flow construction service 352. At 412, an IVR flow 354 is constructed based on the intent with the highest assigned intent valuation score, provided by the pre-trained LLM 324. At 414, the created IVR flow is validated, based on various parameters such as, but not limited to sequence of flows, customer preferred language, customer type and predefined agent, and assigned a quality score. At 416, IVR flow validation module 356 transmits quality score to the pre-trained LLM 324 for reinforcement learning. The quality score assigned by the IVR flow validation module 354 ranges between 0 to 1. The IVR flow validation module 354 also defines a dynamic threshold value for the quality score, based on various parameters in the created IVR flow such as, but not limited to sequence of flows, business requirements, language, customer type and predefined agent. The quality score below the dynamic threshold value indicates erroneous IVR flow construction, whereas the quality score above the dynamic threshold value indicates higher accuracy in the constructed IVR flow.

At 418, if on obtaining a quality score below the dynamic threshold value the IVR flow validation module transmits an alert to the user/consultant 302 for manual validation.

At 418, the IVR flow validation module on identifying that the quality score is above the dynamic threshold value transmits the IVR flow to the deployment module 358 for deployment 422.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the present application as defined by the following claims and the equivalents thereof. That which is claimed:

1. A system for identifying relevant intents from an inbound interaction of a conversation bot, to construct customized Interactive Voice Response (IVR) flows, the system comprising:
a contextual embedding module, to generate a vector database and an input vector representation database wherein the vector database is generated by contextually embedding information in a knowledge base and the input vector representation database is generated by contextually embedding the inbound interaction of the conversation bot;
an utterance context identification module, to identify a list of potentially relevant utterances in the vector database generated by the contextual embedding module, which are contextually similar to the input vector representation database generated by the contextual embedding module, and re-rank the identified list of potentially relevant utterances to obtain a reranked list of potentially relevant utterances;
a pretrained LLM, to match a relevant intent to each of the potentially relevant utterances in the re-ranked list derived from the context identification module and assign intent valuation scores to each of the intents matched;
an IVR flow construction service, to construct customized IVR flows based on the intent with the highest intent valuation score assigned by the pre-trained LLM; and
an IVR flow validation module, to validate the constructed customized IVR flow by the IVR flow construction service.

2. The system of claim 1, wherein the knowledge base utilized for creating the vector database is based on at least one of existing customer flows and user inputs.

3. The system of claim 1, wherein the inbound interaction of the conversation bot is either a voice input or text input.

4. The system of claim 1, wherein the IVR flow validation module assigns a quality score to the constructed customized IVR flow.

5. The system of claim 1, wherein the IVR flow validation module transmits the assigned quality score to the pre-trained LLM for reinforcement learning of the pre-trained LLM in real time.

6. The system of claim 4, wherein the quality score assigned by the IVR flow validation module ranges between 0 and 1.

7. The system of claim 1, wherein the IVR flow validation module defines a dynamic threshold value for the quality score.

8. The system of claim 1, wherein the IVR flow validation module, on obtaining a quality score below the dynamic threshold value for the constructed customized IVR flow, transmits an alert to the user for manual validation.

9. The system of claim 1, wherein the IVR flow validation module, on obtaining a quality score above the dynamic threshold value for the constructed customized IVR flow, transmits the constructed customized IVR flow to the deployment module for deployment.

10. A method for identifying relevant intents from an inbound interaction of a conversation bot, to construct customized Interactive Voice Response (IVR) flows, the method comprising:
generating, by a contextual embedding module, a vector database and an input vector representation database wherein the vector database is generated by contextually embedding information in a knowledge base and the input vector representation database is generated by contextually embedding the inbound interaction of the conversation bot;
identifying, by an utterance context identification module a list of potentially relevant utterances in the vector database generated by the contextual embedding module, which are contextually similar to the to the input vector representation database generated by the contextual embedding module, and re-rank the identified list of potentially relevant utterances to obtain a reranked list of potentially relevant utterances;
matching, by the pretrained LLM a relevant intent to each of the potentially relevant utterances in the re-ranked list derived from the context identification module and assigning intent valuation scores to each of the intents matched;
constructing, by an IVR flow construction service, customized IVR flows based on the intent with the highest intent valuation scores assigned by the pre-trained LLM; and
validating, by a IVR flow validation module, the constructed customized IVR flow.

11. The method of claim 10, wherein the knowledge base utilized for creating the vector database is based on at least one of existing customer flows and user inputs.

12. The method of claim 10, wherein the inbound interaction of the conversation bot is either a voice input or text input.

13. The method of claim 10, wherein the IVR flow validation module assigns a quality score to the constructed customized IVR flow.

14. The method of claim 10, wherein the IVR flow validation module transmits the assigned quality score to the pre-trained LLM for reinforcement learning of the pre-trained LLM in real time.

15. The method of claim 13, wherein the quality score assigned by the IVR flow validation module ranges between 0 and 1.

16. The method of claim 10, wherein the IVR flow validation module defines a dynamic threshold value for the quality score.

17. The method of claim 10, wherein the IVR flow validation module, on obtaining a quality score below the dynamic threshold value for the constructed customized IVR flow, transmits an alert to the user for manual validation.

18. The method of claim 10, wherein the IVR flow validation module, on obtaining a quality score above the dynamic threshold value for the constructed customized IVR flow, transmits the constructed customized IVR flow to the deployment module for deployment.

19. The method of claim 10, wherein the context identification module is based on a RAG model.

20. The method of claim 10, wherein the pre-trained LLM includes a Claude Large Language model or a Flan Model.
